(19) United States
(12) Patent Application Publication
(10) Pub. No.: US 2013/0121308 A1
(43) Pub. Date: May 16, 2013

(54) COMMUNICATION CONFIGURATION

(71) Applicant: Vikas Dhingra, Bangalore (IN)

(72) Inventor: Vikas Dhingra, Bangalore (IN)

(21) Appl. No.: 13/578,292

(22) PCT Filed: Jan. 4, 2011
(86) PCT No.: PCT/EP11/50057

§ 371 Date: Jan. 25, 2013

(30) Foreign Application Priority Data
Feb. 11, 2010 (IN) 338/CHE/2010

(51) Int. Cl. H04W 36/08

(52) U.S. Cl. CPC H04W 36/08
USPC 370/331

(57) ABSTRACT

A base station method of communications configuration, a user equipment method of communications configuration, a base station, user equipment and computer program products are disclosed. The base station method of configuring communication between a target serving cell associated with a target base station and user equipment having preconfigured radio link configuration information specifying a preconfigured communications arrangement in which a predetermined set of radio carriers are to be utilised for communication with the target base station in accordance with a predetermined communication scheme on a serving cell change, comprises the steps of: determining whether the target base station associated with the target serving cell is able to support the preconfigured communications arrangement; and if not, providing a control message from the target base station to the user equipment on the serving cell change, the control message encoding an indication to cause the user equipment to establish an alternative communications arrangement.

### FIELD OF THE INVENTION

The present invention relates to a base station method of communications configuration, a user equipment method of communications configuration, a base station, user equipment and computer program products.

### BACKGROUND

Single carrier wireless telecommunication systems based on Wideband Code Division Multiple Access (WCDMA) or Universal Mobile Telecommunications Systems (UMTS) are known. In those known systems, radio coverage is provided to user equipment, for example, mobile telephones, by geographical area. A base station is located in each geographical area to provide the required radio coverage, often referred to as a cell. User equipment in the area served by a base station receives information and data from the base station and transmits information and data back to the base station. Downlink refers to transmission of information and data by the base station to the user equipment. Uplink refers to transmission of Information and data by user equipment to the base station.

In known wireless telecommunications systems operating in a single carrier mode, user equipment can move between geographical base station areas. Single base stations can also cover multiple geographical areas. Service provided to user equipment is overseen by a radio network controller (RNC). The radio network controller communicates with user equipment and base stations and determines which base station each user equipment is primarily connected to. Furthermore, the radio network controller acts to control and communicate with base stations and user equipment when user equipment moves from the geographical area served by one base station to a geographical area served by another base station or between geographical areas served by the same base station, such a mobility event is often referred to as hand-off or hand-over.

As well as single carrier arrangements, it is also known to provide multi-carrier arrangements in which more than one carrier is provided within a single radio link. This increases data throughput on that radio link by simultaneously transmitting data through multiple carriers.

It has been proposed to allow base stations and user equipment to each transmit simultaneously on more than one radio link. Furthermore, it has been proposed to allow user equipment and base stations to receive simultaneously on more than one carrier. Each carrier, both uplink and downlink, is typically independently power controlled and independently scheduled by a base station. Provision of more than one downlink, for example, on a number of different carriers, allows for an increase in data throughput to the user equipment. Networks having two simultaneous carriers in downlink for HSDPA may be referred to as “dual cell high speed downlink packet access” (DC-HSDPA) networks. Networks having more than two simultaneous carriers in downlink and/or uplink may be referred to as “multi cell high speed packet access” (MC-HSPA) networks. The term “multi cell” networks used herein is envisaged to cover the case where two, three, four carriers (either in downlink or uplink) are provided for in the network. In HSDPA telecommunications networks, data and information is sent between a base station and user equipment in data packets on radio frequency (RF) carriers.

To support MC-HSPA in a network, such as in a universal terrestrial radio access network (UTRAN) each coverage area, also known as a cell, can be supported by one or different base stations. Each user equipment when supporting MC-HSPA may receive simultaneously signals from multiple cells supported by the same or different base stations. Accordingly, it is necessary to ensure that both the user equipment and the base stations supporting the cells to which the user equipment is attached are configured correctly to communicate with each other. Furthermore, mechanisms need to exist to ensure that should the user equipment no longer be able to continue communications with the existing cells, then communication can be established with alternative cells. Such a situation typically occurs when user equipment travels out of the coverage area provided one base station and enters the coverage area provided by another, or between coverage areas served by the same base station. To facilitate this, the user equipment, which is currently communicating with radio links in the “active set”, monitors the pilot signals from other neighbouring cells. This information is provided to the radio network controller which determines whether the reported neighbouring cell is likely to be required to play the role of serving cell in the future. If the assessment is that the reported neighbouring cell could be utilised as a serving cell in the future, then pre-configuration information is transmitted to the user equipment, which is stored in the memory of the user equipment and which may subsequently be used by the user equipment to support communication with that particular cell. Likewise, the radio network controller informs the base station associated with the reported neighbouring cell, which in turn commits resources for use by the user equipment, should this be required after serving cell change. Should the user equipment then move to the coverage area provided by one of radio links in the active set, the user equipment senses the proximity with that cell by receiving strong pilot signals from that cell and may utilise the pre-configuration information during the serving cell change procedure and also after completing serving cell change to that cell.

Although this approach helps improve the reliability of handover from a source serving cell to a target serving cell, unexpected consequences can occur. Accordingly, it is desired to provide an improve technique for controlling communication on a change of a serving cell.

### SUMMARY

According to a first aspect, there is provided a base station method of configuring communication between a target serving cell associated with a target base station and user equipment having preconfigured radio link configuration information specifying a preconfigured communications arrangement in which a predetermined set of carriers are to be utilised for communication with the target base station in accordance with a predetermined communication scheme on a serving cell change, the method comprising the steps of: determining whether the target base station associated with the target serving cell is able to support the preconfigured communications arrangement; and if not, providing a control message from the target base station to the user equipment on the serving cell change, the control message encoding an indication to cause the user equipment to establish an alternative communications arrangement.

The first aspect recognises that a problem with existing techniques is that the target base station supporting the target serving cells may attempt to support communications using an alternative communications arrangement to that expected by the user equipment. For example, when the user equipment first detected the presence of the neighbouring cell, the radio network controller may have communicated with the target base station associated with that neighbouring cell to determine whether it is able to support the user equipment when communicating using a particular communications arrangement. The target base station may then have committed resources to support the user equipment in accordance with that communications arrangement. The radio network controller would then have communicated this to the user equipment which would have stored that as a pre-configured communications arrangement to be used when communicating with that target base station. However, a situation can occur where the target base station is unable to actually allocate the required resources to the user equipment when handover occurs and so the target base station is unable to communicate with the user equipment in accordance with the pre-configured communications arrangement. Although this can be communicated back to the user equipment through the source cell by the radio network controller, the first aspect also recognises that when fast fading with the source serving cell occurs (such as may occur in poor radio frequency (RF) conditions like an urban canyon-like scenario where the serving cell signal strength degrades significantly in a short period of time), the reliability of reception of this communication by the user equipment is considerably reduced. Also, although repetitions in the form of hybrid automatic repeat requests (HARQ) may be performed for these arrangements, these might also not help much under the above-mentioned radio channel conditions and intended communication may never be received by the user equipment, or may arrive too late to prevent a call being dropped. Hence, although the user equipment may have pre-configured information stored in the user equipment and, therefore, may be able to receive messages from the target base station, the user equipment will reconfigure itself as per that pre-configured information. This results in an inconsistency where the user equipment is configured to operate in accordance with a particular communications arrangement, whereas the target base station is configured to operate in accordance with an alternative communications arrangement. This can lead to incorrect decoding of information transmitted between the user equipment and the target base station. This can lead to unexpected consequences such as an incorrect estimation of radio channel conditions which may result in the under-allocation of transmission power or the over-allocation of transmission power, thus reducing the amount of power available for other user equipment.

Accordingly, a determination may be made of whether the target base station supporting the target serving cell is able to perform communications with the user equipment in accordance with the pre-configured arrangement. If it is no longer possible to communicate with the user equipment using that pre-configured arrangement, then a control message may be provided to the user equipment during the serving cell change procedure and before the user equipment has actually performed serving cell change to the target serving cell supported by that base station. The message may contain an indication which causes the user equipment to establish communications using an alternative communications arrangement. For example, both the user equipment and the target base station may have a specified default or minimum communications arrangement supported by all base station and user equipment. The information encoded in the control message may indicate to the user equipment that such a default alternative communications arrangement will be utilised. In this way, it can be seen that any enhanced communication arrangement which was previously indicated in pre-configured information stored in the user equipment as being supported by the target base station may be changed to a default communications arrangement when that target base station determines that it is no longer able to establish communications using that pre-configured arrangement. Hence, it can be seen that through the provision of this control message, the mismatch in communications arrangement between the target base station and the user equipment may be rectified. It will be appreciated in this context that to say that the predetermined communication scheme is utilised on a serving cell change indicates that the user equipment is preconfigured to attempt to utilise the predetermined communications scheme to communicate with the target base station when a serving cell change occurs. Likewise, it will be appreciated in this context that to say that a control message is provided from the target base station to the user equipment on or during the serving cell change indicates that the control message is sent at a point in time on or after the serving cell change has started or been initiated, that serving cell change taking a period of time or having certain duration in time.

In one embodiment, the control message encodes the indication to cause the user equipment to establish the alternative communications arrangement utilising at least one of the set of carriers. Accordingly, the alternative communications arrangement may still use one of the predetermined set of uplink or downlink carriers.

In one embodiment, the control message encodes the indication to cause the user equipment to establish the alternative communications arrangement utilising an alternative communication scheme. Accordingly, a change in the communications scheme or regime may be signalled in the control message. Hence, a different communications scheme, such as a default communications scheme, may be activated to replace the previously configured scheme specified for that target base station.

In one embodiment, the predetermined communications scheme comprises at least one of Multi-Cell High Speed Packet Access and Multiple-Input Multiple-Output and the alternative communications scheme comprises at least one of Single-Cell High Speed Packet Access and Single-Input Single-Output. This indication may, for example, indicate to the user equipment to change from the expected multi-cell high speed packet access scheme to a default single-cell high speed packet access scheme. Likewise, the control message may indicate to the user equipment to operate in a single-input single-output rather than a multiple-input multiple-output mode.

In one embodiment, the control message encodes the indication to cause the user equipment to establish the alternative communications arrangement utilising the set of carriers. Hence, it may be that communication is still to be established with each of those uplink or downlink carriers within the set, but using a different communications scheme.

In one embodiment, the control message encodes the indication to cause the user equipment to establish the alternative communications arrangement utilising a subset of the set of carriers. Accordingly, the expected communications scheme may still be utilised, but using a subset of the total number of pre-configured uplink or downlink carriers. Alternatively, a subset of those uplink or downlink carriers may be utilised using an entirely different communications scheme.

In one embodiment, the set of carriers comprises an anchor carrier and at least one supplementary carrier.

In one embodiment, the control message encodes an indication to cause the user equipment to utilise the anchor carrier and at least one supplementary carrier.

In one embodiment, the control message encodes an indication to cause the user equipment to utilise only the anchor carrier.

In one embodiment, the control message comprises a High Speed Shared Control Channel order provided over a High Speed Shared Control Channel between the target base station and the user equipment on serving cell change. Hence, the indication may be provided within a pre-existing message already transmitted between the base station and user equipment.

In one embodiment, the indication is encoded as predefined sequence of a number of bits within the High Speed Shared Control Channel order utilised to provide other information. The indication may be encoded in the existing message through a combination of bits (which may be already allocated to provide other information to the user equipment) being set in a particular combination or pattern. For example, some of the bits may indicate a particular status to the user equipment and combinations of those bits would normally appear illogical for the information that those bits normally encode. However, the occurrence of such an illogical combination of bits may be utilised to provide the indication to the user equipment within the existing message structure, without needing to expand the number of bits currently allocated to that message. It will be appreciated that more than one indication may be encoded within the order message.

In one embodiment, the method comprises the step of: providing an indication of the alternative communications arrangement to a Radio Network Controller associated with the base station. Accordingly, an indication may also be provided to the radio network controller to ensure that the radio network controller is also aware of the communications arrangement currently being supported between the user equipment and the base station. This prevents a mismatch in the configuration status stored in the radio network controller.

In one embodiment, the radio network controller is operable to provide an indication of the alternative communications arrangement to a source base station for transmission to the user equipment. As mentioned above, the reliability of reception of this communication by the user equipment is considerably reduced.

According to a second aspect, there is provided a base station operable configuring communication with user equipment having preconfigured radio link configuration information specifying a preconfigured communications arrangement in which a predetermined set of carriers are to be utilised for communication with the base station in accordance with a predetermined communication scheme on a serving cell change, the base station comprising: determination logic operable to determine whether the base station is able to support the of the preconfigured communications arrangement; and control message logic operable, in response to an indication from the determination logic that the base station is not able to support the preconfigured communications arrangement, to provide a control message to the user equipment on the serving cell change, the control message encoding an indication to cause the user equipment to establish an alternative communications arrangement. Hence, it will be appreciated that the control message may be provided to the user equipment during the serving cell change procedure and before the user equipment has actually performed serving cell change to the target serving cell supported by that base station.

In one embodiment, the control message encodes the indication to cause the user equipment to establish the alternative communications arrangement utilising an alternative communication scheme.

In one embodiment, the predetermined communications scheme comprises at least one of Multi Cell High Speed Packet Access and Multiple-Input Multiple-Output and the alternative communications scheme comprises at least one of Single Cell High Speed Packet Access and Single-Input Single-Output.

In one embodiment, the control message encodes the indication to cause the user equipment to establish the alternative communications arrangement utilising the set of carriers.

In one embodiment, the control message encodes the indication to cause the user equipment to establish the alternative communications arrangement utilising a subset of the set of carriers.

In one embodiment, the set of carriers comprises an anchor carrier and at least one supplementary carrier.

In one embodiment, the control message encodes an indication to cause the user equipment to utilise the anchor carrier and at least one supplementary carrier.

In one embodiment, the control message encodes an indication to cause the user equipment to utilise only the anchor carrier.

In one embodiment, the control message comprises a High Speed Shared Control Channel order provided over a High Speed Shared Control Channel between the target base station and the user equipment on the serving cell change.

In one embodiment, the indication is encoded as predefined sequence of a number of bits within the High Speed Shared Control Channel order utilised to provide other information.

In one embodiment, the control message logic is operable to provide an indication of the alternative communications arrangement to a Radio Network Controller associated with the base station.

In one embodiment, the radio network controller is operable to provide an indication of the alternative communications arrangement to a source base station for transmission to the user equipment.

According to a third aspect, there is provided a user equipment method of configuring communication between a target base station and the user equipment, the method comprising the steps of: pre-storing preconfigured radio link configuration information specifying a preconfigured communications arrangement in which a predetermined set of carriers are to be utilised for communication with the target base station in accordance with a predetermined communication scheme on a serving cell change; and receiving a control message from the target base station on the serving cell change, the control message encoding an indication to cause the user equipment to establish an alternative communications arrangement. Hence, it will be appreciated that the control message may be provided to the user equipment during the serving cell change procedure and before the user equipment has actually performed serving cell change to the target serving cell supported by that base station.

In one embodiment, the radio network controller is operable to provide an indication of the alternative communications arrangement to a source base station for transmission to the user equipment.

According to a fourth aspect, there is provided user equipment operable to configure communications between a target base station and the user equipment, comprising: storage operable to pre-store preconfigured radio link configuration information specifying a preconfigured communications arrangement in which a predetermined set of carriers are to be utilised for communication with the target base station in accordance with a predetermined communication scheme on a serving cell change; and control logic operable to receive a control message from the target base station on serving cell change and to establish a an alternative communications arrangement in response to an indication encoded in the control message. Hence, it will be appreciated that the control message may be provided to the user equipment during the serving cell change procedure and before the user equipment has actually performed serving cell change to the target serving cell supported by that base station.

According to a fifth aspect, there is provided a computer program product operable, when executed on a computer, to perform the method steps of the first and third aspect.

Further particular and preferred aspects of the present invention are set out in the accompanying independent and dependent claims. Features of the dependent claims may be combined with features of the independent claims as appropriate, and in combinations other than those explicitly set out in the claims.

### BRIEF DESCRIPTION OF THE DRAWINGS

Embodiments of the present invention will now be described further, with reference to the accompanying drawings, in which:

FIG. 1 illustrates a wireless communications system according to one embodiment; and

FIG. 2 illustrates messages transmitted between the network nodes of FIG. 1.

### DESCRIPTION OF THE EMBODIMENTS

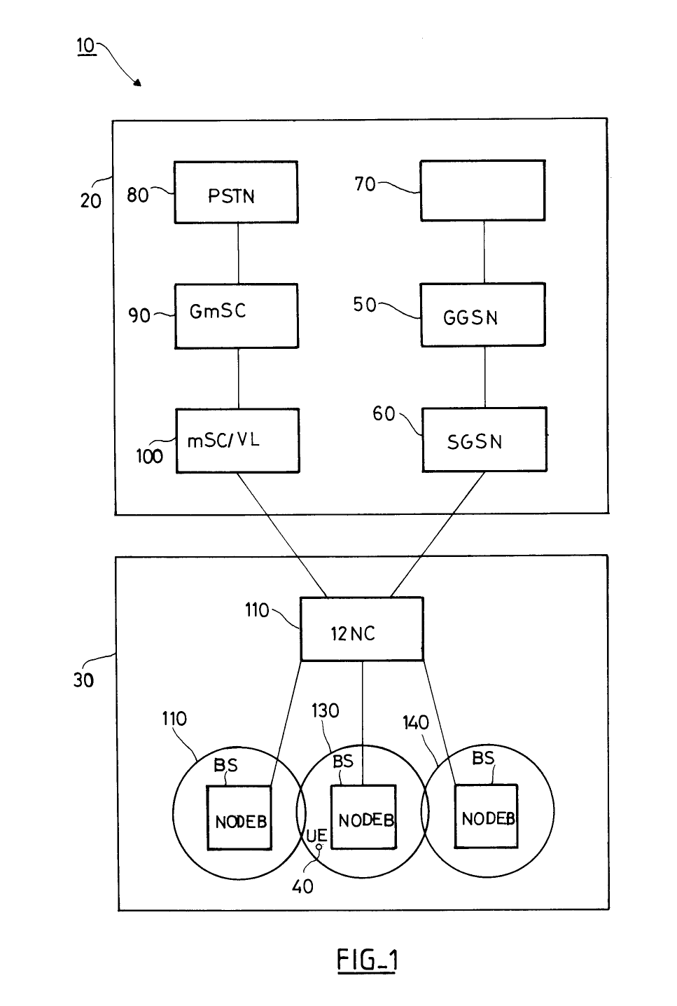

FIG. 1 illustrates a wireless communications system, generally 10. The wireless communications system includes a core network 20 and a universal terrestrial radio access network (UTRAN) 30. The wireless communications system 20 provides voice and data services to user equipment 40. The core network 20 comprises a general packet radio service gateway support node (GGSN) 50 coupled with a serving general packet radio system support node (SGSN) 60. The GGSN 50 is connected with a network 70, such as the Internet. This provides a packet data route from the network 70 through the GGSN 50, SGSN 60 and onto the UTRAN 30. Similarly, a public switched telephone network (PSTN) 80 is coupled with a gateway mobile switching centre (GMSC) 90 and onto a mobile switching centre (MSC) which has a visitor location register (VLR) 100. Voice services can therefore be routed from the PSTN 80 to the GMSC 90 onto the MSC/VLR 100 and onto the UTRAN 30.

Within the UTRAN 30 there is provided a radio network controller (RNC) 110 which is coupled with a plurality of base stations BS₁, BS₂ and BS₃. Each base station supports one or more serving cells 120, 130, 140.

As mentioned above, the user equipment 40 is mobile and therefore is able to roam among different cells. The user equipment 40 monitors pilot signals from all the receivable cells and stores this information, together with pre-configuration information provided by the RNC 110, as will be described in more detail below. These receivable cells are known as the “active set”.

In the arrangement shown in FIG. 1, the user equipment 40 is close to the base station BS₂, but is moving towards base station BS₁. Hence, the user equipment 40 may sense the pilot transmissions from the base station BS₁. Since the transmissions from the base station BS₂ are stronger, the user equipment 40 may be instructed to first communicate with the cell associated with base station BS₂. However, since the user equipment 40 has sensed the presence of cell associated with the base station BS₁, the user equipment 40 has information relating to the radio links with BS₂ and BS₁ in its active set. This information is pre-configured and is provided by the RNC 110 following a request to the base station BS₁ to commit resources for the future use of user equipment 40, should it subsequently require to be supported by that base station. Should the base station consider it would be able to support the user equipment 40, then it commits those resources and provides the necessary communications information to the RNC 110 for onward transmission to the user equipment 40. The RNC 110 provides this information in a radio resource control active set update which provides a target cell pre-configuration information element providing a downlink secondary cell information frequency division duplex information element, which provides carrier information and which is stored by the user equipment 40. This information enables the user equipment 40 to perform HS-DSCH reception procedures for the target cell as well as transmit using a high speed dedicated physical control channel (HS-DPCCH) in accordance with the DC-HSDPA scheme to the target base station BS₁. Although in this example the cells are supported by different base stations, it will be appreciated that different cell may be supported by the same base station.

When the user equipment 40 undergoes a mobility event involving the target base station BS₁, the pre-configured information enables the user equipment 40 to establish communications with the target base station BS₁ even when no signalling message can be provided by the source base station BS₂ to complete the handover due to temporary or permanent loss of the radio link with the source base station BS₂. Instead, the target base station BS₁, aware of the existence of the user equipment 40, can transmit a HS-SCCH order to the user equipment 40 which, on receipt of that order, will cause the user equipment 40 to configure itself as per the pre-configured information to in order to establish predefined radio links with the target base station BS₁ and communicate in accordance with a predefined communications scheme. As also mentioned above, although this, in many circumstances enables handover to the target base station BS₁ to occur correctly, a problem that can occur is that in the period between which the target base station BS₁ was asked to commit resources to support the user equipment 40 (upon which the pre-configured information is based) and the time when the target base station BS₁ actually needs to reserve those resources for the use by that user equipment 40, the target base station BS₁ may no longer be able to allocate all those resources to the user equipment 40. It will be appreciated that there may be other reasons why the target base station BS₁ or even the radio network controller 110 may no longer be able to support the user equipment 40 in the way previously intended.

Should the alternative communications arrangement not be possible to be communicated via the RNC 110 and the source base station BS₂ to the user equipment 40, then the target base station BS₁ and the user equipment 40 will be attempting to communicate with each other using different communications arrangements, as will be described in more detail below. Although, as mentioned above, the user equipment 40 is able to use the pre-configured information to receive a HS-SCCH order from the target base station BS₁, the existing order simply informs the user equipment 40 to utilise the currently stored pre-configured information to communicate with the target base station BS₁, which results in a mismatch. Accordingly, the content of the HS-SCCH order has been manipulated in order to indicate to the user equipment 40 that is should utilise a different communications arrangement with the target base station BS₁. This alternative arrangement may be a simplified or minimal communications scheme to which both the user equipment 40 and the target base station BS₁ will default. For example, the pre-configured information may relate to an enhanced communications scheme such as DC-HSDPA using a primary or anchor carrier (sometimes referred to as a serving HS-DSCH cell) and one or more secondary or supplementary carriers (sometimes referred to as a secondary HS-DSCH serving cell) and the default arrangement is to perform communication using just the anchor carrier. Likewise, the pre-configured information may specify that the user equipment is to establish MIMO communications with the target base station and the default alternative arrangement may be to support SISO communications.

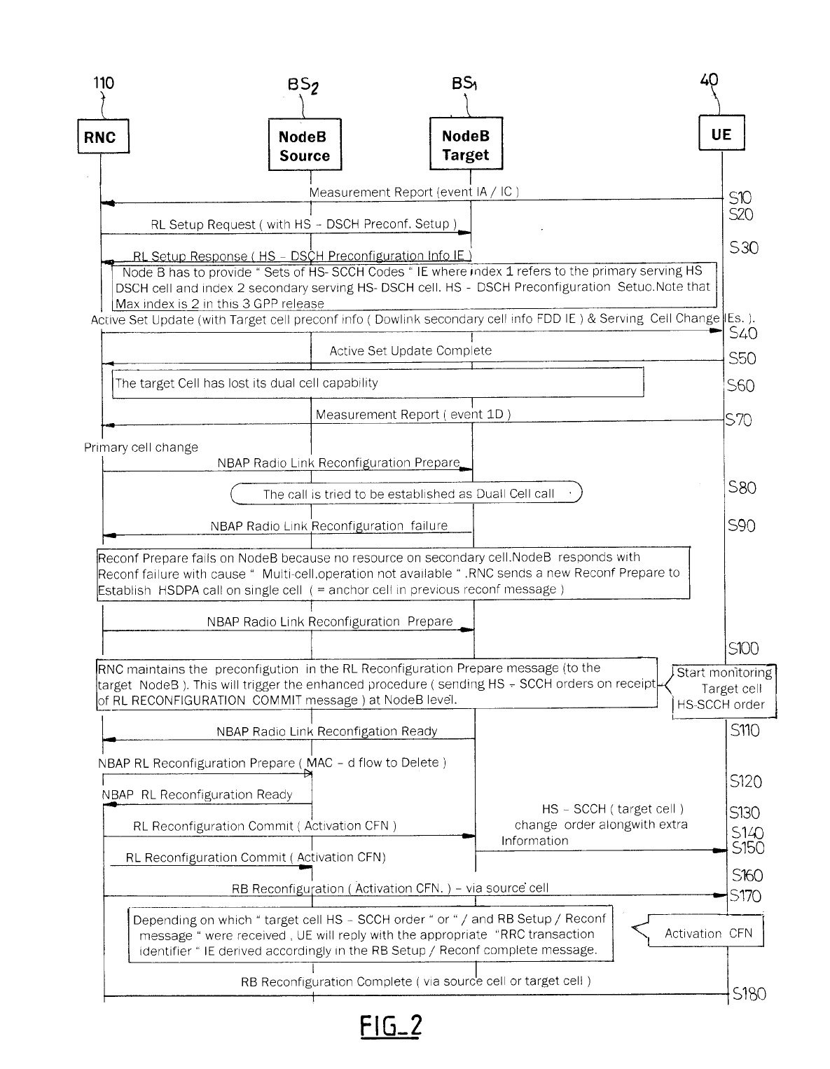

FIG. 2 illustrates the flow of communications messages between network nodes during handover when using the modified HS-SCCH order. As mentioned above, in this arrangement, the user equipment 40 is currently being supported by the source base station BS₂. However, the user equipment has detected the pilot signals from cells associated with the target base station BS₁ and noted that these are of comparable strength to that of the source base station BS₂. This triggers a measurement report referred to as an “Event 1A/1C” message which is transmitted to the RNC 110 via the source base station BS₂, as shown at step S10.

The RNC 110 sends a radio link (RL) setup request message at step S20 to the target base station BS₁ which includes HS-DSCH pre-configuration setup information.

The target base station BS₁ determines whether it is able to commit resources to support user equipment 40 and, if so, at step S30, sends an RL set-up response message back to the RNC 110 which includes an HS-DSCH pre-configuration information element which identifies sets of HS-SCCH codes, one of which refers to a primary serving HS-DSCH cell and one of which refers to a secondary serving HS-DSCH serving cell.

At step S40, the RNC 110 transmits, via the source base station BS₂, an active set update which includes target cell pre-configuration information (which includes downlink secondary cell information frequency division duplex information elements) and serving cell change information elements. This information is stored in the user equipment 40 and defines a pre-configured communications arrangement which the user equipment 40 can utilise when communicating with the target base station BS₁ after serving cell change.

At step S50, the user equipment 40 transmits a message back to the RNC 110 via the source base station BS₂ to indicate that the active set update has completed.

Sometime thereafter, the target base station BS₁ loses its ability to support dual cell communications.

At step S70, the user equipment makes a decision that it wishes to handover to the target base station BS₁ and transmits a measurement report (known as an “event 1d”) message via the source base station BS₂.

The RNC 110 determines that a handover should occur and, at step S80, sends a NodeB application part (NBAP) radio link reconfiguration prepare message to the target base station BS₁. Meanwhile, the user equipment 40 starts monitoring for a target cell HS-SCCH order. The NBAP radio reconfiguration prepare message indicates to the target base station BS₁ that a dual-cell call is requested to be established.

However, at step S90, the target base station BS₁ determines that it is no longer able to support a dual-cell call and so sends an NBAP radio link reconfiguration failure back to the RNC 110 indicating that multi-cell operation is not available.

Accordingly, at step S100, the RNC 110 responds with a revised radio link reconfiguration prepare message indicating to the target base station BS₁ that communication should be established using HSDPA on a single cell. This single cell will typically be the primary or anchor cell previously permitted for use with the user equipment 40 and indicated in the active set update message sent at step S40.

At step S110, the target base station BS₁ determines that it has sufficient resources to establish an HSDPA call on the primary serving cell and responds with an NBAP radio link reconfiguration ready message which is sent to the RNC 110.

At step S120, the RNC 110 sends an NBAP radio link reconfiguration prepare message to the source base station BS₂, which responds with an NBAP radio link reconfiguration ready message at step S130.

At step S140, the RNC 110 transmits a radio link reconfiguration commit message which include an activation connection frame number.

At step S150, the target base station BS₁ determines that its configuration differs to the pre-configuration information provided to the RNC 110 at step S30 and forwarded as an active set update to the user equipment 40 at step S40. Accordingly, the target base station BS₁ transmits a HS-SCCH order to the user equipment 40. The HS-SCCH order encodes an indication within the existing bit fields which is detectable by the user equipment 40 to indicate that an alternative communications arrangement to that pre-configured within the user equipment 40 should be used to communicate with the target base station BS₁. As will be mentioned in more detail below, various schemes may be used to encode the information within the order message in order to convey this indication to the user equipment 40. On receipt of that message by the user equipment 40, the user equipment 40 will attempt to establish communications with the target base station BS₁ using that alternative communications arrangement. For example, in this example, the presence of the indication within the control message may indicate to the user equipment 40 that rather than performing DC-HSDPA with the target base station BS₁, the user equipment 40 should instead perform SC-HSDPA using the anchor carrier. Of course, as mentioned above, various other communications scheme changes could be conveyed to the user equipment 40 such as using dual-carriers rather than multi-carriers on the uplink and/or downlink. Likewise, the indication may cause the user equipment 40 to switch from a MIMO pre-configuration to a SISO configuration when communicating with the target base station BS₁.

At step S160, the RNC 110 transmits a radio link reconfiguration commit message to the source base station BS₂ which causes the source base station to take down its HSDPA channels (although it may retain uplink channels and any other dedicated channels).

At step S170, the RNC 110 transmits a radio bearer (RB) reconfiguration message to the user equipment 40 via the source base station BS₂. As previously mentioned, this message may not be received by the user equipment 40, or may not be received by the user equipment 40 in time to enable handover to occur.

Hence, at step S180, dependent on whether the user equipment 40 responded to the HS-SCCH order or the RB reconfiguration message, the user equipment 40 will transmit an RB reconfiguration complete message either via the source BS₂ or via the target base station BS₁ to the RNC 110.

Accordingly, it can be seen that additional information is sent in the HS-SCCH order from the target serving cell specifying whether the secondary serving cell should be activated or not in the user equipment 40 after executing a serving cell change. This additional information is encoded within an existing HS-SCCH order. After receiving this additional information in the HS-SCCH order from the non-serving cell (the configured future serving cell) the user equipment 40 has the possibility to discard information stored on the downlink secondary cell info FDD received through target cell pre-configuration information during active cell update. Thus, the user equipment 40 can execute a serving cell change procedure at the activation time considering only the target serving cell and not configuring the secondary serving cell at all during a mobility event. However, if this additional information is either not present in the HS-SCCH order or it signifies that the secondary serving cell has to be activated after serving cell change, the existing procedures can be followed without modification.

HS-SCCH orders are commands sent to the user equipment using HS-SCCH, as specified in 3GPP TS 25.212 Version (9.1.0). Following is the current encoding scheme used for current HS-SCCH orders from NodeB to UE for various commands.

If the order is transmitted from the serving HS-DSCH cell, for this Order type, X_{ord,1}, X_{ord,2}, X_{ord,3} is comprised of:
DRX activation (1 bit): X_{ord,1}=X_{drx,1}
DTX activation (1 bit): X_{ord,2}=X_{dtx,1}
HS-SCCH-less operation activation (1 bit): X_{ord,3}=X_{hs-scch-less,1}

If x_{drx,1}=‘0’, then the HS-SCCH order is a DRX De-activation order.

If x_{drx,1}=‘1’, then the HS-SCCH order is a DRX Activation order.

If X_{dtx,1}=‘0’, then the HS-SCCH order is a DTX De-activation order.

If X_{dtx,1}=‘1’, then the HS-SCCH order is a DTX Activation order.

If X_{hs-scch-less,1}=‘0’, then the HS-SCCH order is a HS-SCCH-less operation De-activation order.

If X_{hs-scch-less,1}=‘1’, then the HS-SCCH order is a HS-SCCH-less operation Activation order.

If the order is transmitted from a non-serving cell and xord,1, xord,2, xord,3=‘000’, then it is an HS-DSCH serving cell change order.

However, xord,1, xord,2, xord,3=‘001’, is currently not used and so is utilised to inform the user equipment to use an alternative communications arrangement with the target base station by, for example, signifying whether secondary serving cell should be activated after serving cell change or not. Of course, it will be appreciated that other bit patterns may also be currently unused and may be utilised to inform the user equipment to use one or more of the different alternative communications arrangements mentioned above.

Hence, if the order is transmitted from a non-serving cell and xord,1, xord,2, xord,3=‘000’, then it is an HS-DSCH serving cell change order and serving cell change is performed as per existing rules. However, if the order is transmitted from a non-serving cell and xord,1, xord,2, xord,3=‘001’, then it is an HS-DSCH serving cell change order and secondary serving cell (as per stored information) will not be activated as part of serving cell change procedure.

Accordingly, it can be seen that a solution can be provided to the mismatch between the user equipment and the target base station on handover without needing to resort to legacy serving cell change procedures, the user equipment need not unnecessarily configure twin reception chains and the user equipment and base stations have the same view of the status of the call, which results in correct channel state interpretation and handling of control signals and data.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The functions of the various elements shown in the Figures, including any functional blocks labelled as “processors” or “logic”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” or “logic” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the Figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. A base station method of configuring communication between a target serving cell associated with a target base station and user equipment having preconfigured radio link configuration information specifying a preconfigured communications arrangement in which a predetermined set of carriers are to be utilised for communication with said target base station in accordance with a predetermined communication scheme on a serving cell change, said method comprising the steps of:
determining whether said target base station associated with the target serving cell is able to support said preconfigured communications arrangement; and
if not, providing a control message from said target base station to said user equipment on said serving cell change, said control message encoding an indication to cause said user equipment to establish an alternative communications arrangement.

2. The method of claim 1, wherein said control message encodes said indication to cause said user equipment to establish said alternative communications arrangement utilising an alternative communication scheme.

3. The method of claim 1, wherein said predetermined communications scheme comprises at least one of Multi Cell High Speed Packet Access and Multiple-Input Multiple-Output and said alternative communications scheme comprises at least one of Single Cell High Speed Packet Access and Single-Input Single-Output.

4. The method of claim 1, wherein said control message encodes said indication to cause said user equipment to establish said alternative communications arrangement utilising said set of carriers.

5. The method of claim 1, wherein said control message encodes said indication to cause said user equipment to establish said alternative communications arrangement utilising a subset of said set of carriers.

6. The method of claim 1, wherein said set of carriers comprises an anchor carrier and at least one supplementary carrier.

7. The method of claim 6, wherein said control message encodes an indication to cause said user equipment to utilise said anchor carrier and at least one supplementary carrier.

8. The method of claim 6, wherein said control message encodes an indication to cause said user equipment to utilise only said anchor carrier.

9. The method of claim 1, wherein said control message comprises an High Speed Shared Control Channel order provided over a High Speed Shared Control Channel between said target base station and said user equipment.

10. The method of claim, 9 wherein said indication is encoded as predefined sequence of a number of bits within said High Speed Shared Control Channel order utilised to provide other information.

11. The method of claim 1, comprising the step of: providing an indication of said alternative communications arrangement to a Radio Network Controller associated with said base station.

12. A base station operable configuring communication with user equipment having preconfigured radio link configuration information specifying a preconfigured communications arrangement in which a predetermined set of carriers are to be utilised for communication with said base station in accordance with a predetermined communication scheme on a serving cell change, said base station comprising:
determination logic operable to determine whether said base station is able to support said of said preconfigured communications arrangement; and
control message logic operable, in response to an indication from said determination logic that said base station is not able to support said preconfigured communications arrangement, to provide a control message to said user equipment on said serving cell change, said control message encoding an indication to cause said user equipment to establish an alternative communications arrangement.

13. A user equipment method of configuring communication between a target base station and said user equipment, said method comprising the steps of:
pre-storing preconfigured radio link configuration information specifying a preconfigured communications arrangement in which a predetermined set of carriers are to be utilised for communication with said target base station in accordance with a predetermined communication scheme on a serving cell change; and
receiving a control message from said target base station on said serving cell change, said control message encoding an indication to cause said user equipment to establish an alternative communications arrangement.

14. User equipment operable to configure communications between a target base station and said user equipment, comprising:
storage operable to pre-store preconfigured radio link configuration information specifying a preconfigured communications arrangement in which a predetermined set of carriers are to be utilised for communication with said target base station in accordance with a predetermined communication scheme on a serving cell change; and
control logic operable to receive a control message from said target base station on said serving cell change and to establish a an alternative communications arrangement in response to an indication encoded in said control message.

15. A computer program product operable, when executed on a computer, to perform the method steps of claim 1.
